(19) United States
(12) Patent Application Publication
(10) Pub. No.: US 2012/0195552 A1
(43) Pub. Date: Aug. 2, 2012

(54) ARRAYED WAVEGUIDE GRATING TYPE OPTICAL MULTIPLEXER AND DEMULTIPLEXER

(75) Inventors: Junichi Hasegawa, Tokyo (JP); Kazutaka Nara, Tokyo (JP)

(73) Assignee: FURUKAWA ELECTRIC CO., LTD., Tokyo (JP)

(21) Appl. No.: 13/361,285

(22) Filed: Jan. 30, 2012

Related U.S. Application Data
(63) Continuation of application No. PCT/JP11/64769, filed on Jun. 28, 2011.

(30) Foreign Application Priority Data
Jul. 2, 2010 (JP) 2010-152243

(51) Int. Cl. G02B 6/34

(52) U.S. Cl. 385/37

(57) ABSTRACT

An arrayed waveguide grating type optical multiplexer and demultiplexer which achieves a low crosstalk even when temperature changes is provided, comprising, on a substrate, a waveguide chip in which an arrayed waveguide grating is formed that has a first waveguide, a first slab waveguide, an arrayed waveguide, a second slab waveguide, and a second waveguide, the waveguide chip being divided into two by any of the first and second slab waveguide, and includes a first glass plate to which one side of the arrayed waveguide grating divided into two in the waveguide chip is fixed, a second glass plate to which the other side thereof is fixed, and a compensation member compensating a temperature dependent shift of a light transmission center wavelength of the arrayed waveguide grating, wherein a part for the arrayed waveguide is not fixed to any of the first and second glass plates.

### CROSS-REFERENCES TO RELATED APPLICATIONS

This application is a continuation application of International Application No. PCT/JP2011/064769, filed Jun. 28, 2011, which claims the benefit of Japanese Patent Application No. 2010-152243, filed Jul. 2, 2010. The contents of the aforementioned applications are incorporated herein by reference in their entities.

### TECHNICAL FIELD

The present invention relates to an arrayed waveguide grating type optical multiplexer and demultiplexer having a function of a wavelength multiplexer and demultiplexer which unifies light beams having respective wavelengths different from one another and separates a light beam for each of the wavelengths, and specifically relates to an arrayed waveguide grating type optical multiplexer and demultiplexer which is made athermal (temperature independent).

### BACKGROUND ART

In an arrayed waveguide grating (AWG) playing an important role as a wavelength multiplexer and demultiplexer (MUX/DEMUX), a temperature dependence in the optical refractive index of silica-based glass causes a temperature dependence also in a center wavelength (transmission center wavelength).

The temperature dependence of the center wavelength in an AWG made of the silica-based glass is 0.011 nm/° C., and this is a non-negligibly large value for a use in a D-WDM (Dense-Wavelength Division Multiplexing) transmission system.

Accordingly, in the D-WDM transmission system which has been diversified in recent years, the AWG is strongly desired to be made athermal (temperature independent) without requiring a power supply.

A conventional arrayed waveguide grating type optical multiplexer and demultiplexer (athermal AWG module) which is made athermal by the use of a compensation plate is disclosed in Patent document 1 (refer to FIG. 14). The arrayed waveguide grating type optical multiplexer and demultiplexer 100 shown in FIG. 14 includes a first waveguide 102 formed on a waveguide chip 114, a first slab waveguide 104 connected to the first waveguide 102, a second waveguide 106, a second slab waveguide 108 connected to the second waveguide 106, and an arrayed waveguide 110 connecting the first slab waveguide 104 and the second slab waveguide 108.

This arrayed waveguide grating type optical multiplexer and demultiplexer 100 is cut into two in a part for the first slab waveguide 104 and divided into an input side part 116 including a part 104A of the first slab waveguide 104 and an output side part 118 including the other part 104B of the first slab waveguide 104.

Then, these input side part 116 and output side part 118 are connected to each other by a compensation plate 112. With this configuration, temperature change causes the compensation plate 112 to expand or contract and to move the part 104A of the first slab waveguide 104 and thereby it is possible to correct a wavelength shift due to the temperature change.

With this configuration, even when temperature changes, it is possible to take out light having the same wavelength as that of light input into the second waveguide 106, from the first waveguide 102.

### PRIOR ART DOCUMENT

### Patent Document

Patent document 1: Japanese Patent No. 3434489

### SUMMARY OF INVENTION

However, along with the recent requirement of a further higher speed and higher capacity, there is desired an arrayed waveguide grating type optical multiplexer and demultiplexer in which a low crosstalk can be obtained stably even when temperature changes.

In consideration of the above situation, the present invention aims at providing an arrayed waveguide grating type optical multiplexer and demultiplexer in which a low crosstalk can be obtained stably even when temperature changes.

An invention according to a first aspect of the present invention relates to an arrayed waveguide grating type optical multiplexer and demultiplexer, comprising: a waveguide chip having an arrayed waveguide grating including at least one first waveguide, a first slab waveguide connected to the first waveguide, an arrayed waveguide having one end connected to a side opposite to a side connected with the first waveguide in the first slab waveguide and including a plurality of channel waveguides having respective lengths different from one another and being bent in the same direction, a second slab waveguide connected to the other end of the arrayed waveguide, and a plurality of second waveguides connected in a state provided in parallel to one another on a side opposite to a side connected with the arrayed waveguide in the second slab waveguide, wherein the waveguide chip is divided into a first separated waveguide chip and a second separated waveguide chip in any of the first slab waveguide and the second slab waveguide; a first base for supporting the first separated waveguide chip; a second base for supporting the second separated waveguide chip; and a compensation member compensating a temperature dependent shift of a light transmission center wavelength of the arrayed waveguide grating in the waveguide chip by being expanded and contracted according to a temperature change so that a relative position between the first and second separated waveguide chips is shifted, wherein the first separated waveguide chip is fixed to the first base at least at a part of a region not including the arrayed waveguide and the second separated waveguide chip is fixed to the second base at least at a part of a region not including the arrayed waveguide.

In the arrayed waveguide grating type optical multiplexer and demultiplexer according to the first aspect of the present invention, a part for the arrayed waveguide is not fixed to any of the first and second bases and thereby a low crosstalk can be obtained even when temperature changes.

An invention according to a second aspect of the present invention relates to an arrayed waveguide grating type optical multiplexer and demultiplexer, wherein a part supporting a region including the arrayed waveguide in at least one of the first and second separated waveguide chip is cut out in each of the first and second bases.

In the arrayed waveguide grating type optical multiplexer and demultiplexer according to the second aspect of the present invention, the part to which the arrayed waveguide is not fixed is cut out in each of the first and second bases and thereby it is possible to easily realize a configuration in which the part for the arrayed waveguide in the arrayed waveguide grating is not fixed to any of the first and second bases.

An invention according to a third aspect of the present invention relates to an arrayed waveguide grating type optical multiplexer and demultiplexer, wherein a boundary part of the waveguide chip divided into two is sandwiched and held by a clip in a thickness direction.

In the arrayed waveguide grating type optical multiplexer and demultiplexer according to the third aspect of the present invention, the waveguide chips are sandwiched by the clip in the thickness direction at a dividing part of the arrayed waveguide grating divided into two, and thereby a shift in the thickness direction is prevented from being caused between both of the waveguide chips without being affected by respective dimensional errors of the two bases in the thickness direction when the both sides of the arrayed waveguide grating divided into two are moved relatively by the expansion or contraction of the compensation member.

An invention according to a fourth aspect of the present invention relates to an arrayed waveguide grating type optical multiplexer and demultiplexer, wherein an opening part for positioning the clip is formed in the first and second bases.

In the arrayed waveguide grating type optical multiplexer and demultiplexer according to the fourth aspect of the present invention, by aligning the position of the clip with the opening part formed in the first and second bases, it is easy to align the position of the clip with the dividing part of the arrayed waveguide grating divided into two.

The above explained present invention provides an arrayed waveguide grating type optical multiplexer and demultiplexer in which a low crosstalk can be obtained stably even when temperature changes.

### BRIEF DESCRIPTION OF THE DRAWINGS

FIG. 1A is a plan view showing a configuration of an arrayed waveguide grating type optical multiplexer and demultiplexer according to Embodiment 1.

FIG. 1B is a side view showing a configuration of an arrayed waveguide grating type optical multiplexer and demultiplexer according to Embodiment 1.

FIG. 2A is a plan view showing a configuration of an arrayed waveguide grating type optical multiplexer and demultiplexer according to Embodiment 2.

FIG. 2B is a side view showing a configuration of an arrayed waveguide grating type optical multiplexer and demultiplexer according to Embodiment 2.

FIG. 3A is a plan view showing a configuration of an arrayed waveguide grating type optical multiplexer and demultiplexer according to Embodiment 3.

FIG. 3B is a side view showing a configuration of an arrayed waveguide grating type optical multiplexer and demultiplexer according to Embodiment 3.

FIG. 4 is a cross-sectional view in the thickness direction showing a configuration of a part sandwiched by a clip in the arrayed waveguide grating type optical multiplexer and demultiplexer according to Embodiment 1 or Embodiment 3.

FIG. 5A is a plan view showing a configuration of an arrayed waveguide grating type optical multiplexer and demultiplexer according to Embodiment 4.

FIG. 5B is a side view showing a configuration of an arrayed waveguide grating type optical multiplexer and demultiplexer according to Embodiment 4.

FIG. 6 is an explanatory diagram showing a state in which plural waveguide chips are formed on a wafer.

FIG. 7 is an explanatory diagram showing a state in which an individual waveguide chip is cut out from a wafer on which plural waveguide chips are formed.

FIG. 8 is a plan view showing a configuration of an individual waveguide chip cut out from the wafer.

FIG. 9 is a diagram showing a table describing a circuit parameter of an arrayed waveguide to be used for determining the length of a compensation plate in the arrayed waveguide grating type optical multiplexer and demultiplexer according to Embodiment 1.

FIG. 10 is a graph showing a center wavelength variation when a temperature history is applied to the arrayed waveguide grating type optical multiplexer and demultiplexer according to Embodiment 1 in which bonding is performed on the extension line of a compensation member.

FIG. 11 is a graph showing an evaluation result of a temperature characteristic in the arrayed waveguide grating type optical multiplexer and demultiplexer according to Example 1.

FIG. 12 is a graph showing a loss-wavelength characteristic and a temperature variation thereof in the arrayed waveguide grating type optical multiplexer and demultiplexer of Example 1.

FIG. 13 is a graph showing a loss-wavelength characteristic and a temperature variation thereof in an arrayed waveguide grating type optical multiplexer and demultiplexer of Comparative example 1.

FIG. 14 is a plan view showing a configuration with respect to an example of an conventional arrayed waveguide grating type optical multiplexer and demultiplexer.

FIG. 15A is a plan view showing a configuration of an arrayed waveguide grating type optical multiplexer and demultiplexer which is used in Comparative example 1.

FIG. 15B is a side view showing a configuration of an arrayed waveguide grating type optical multiplexer and demultiplexer which is used in Comparative example 1.

### DESCRIPTION OF EMBODIMENTS

### 1. Embodiment 1

In the following, an example of an arrayed waveguide grating type optical multiplexer and demultiplexer according to the present invention will be explained.

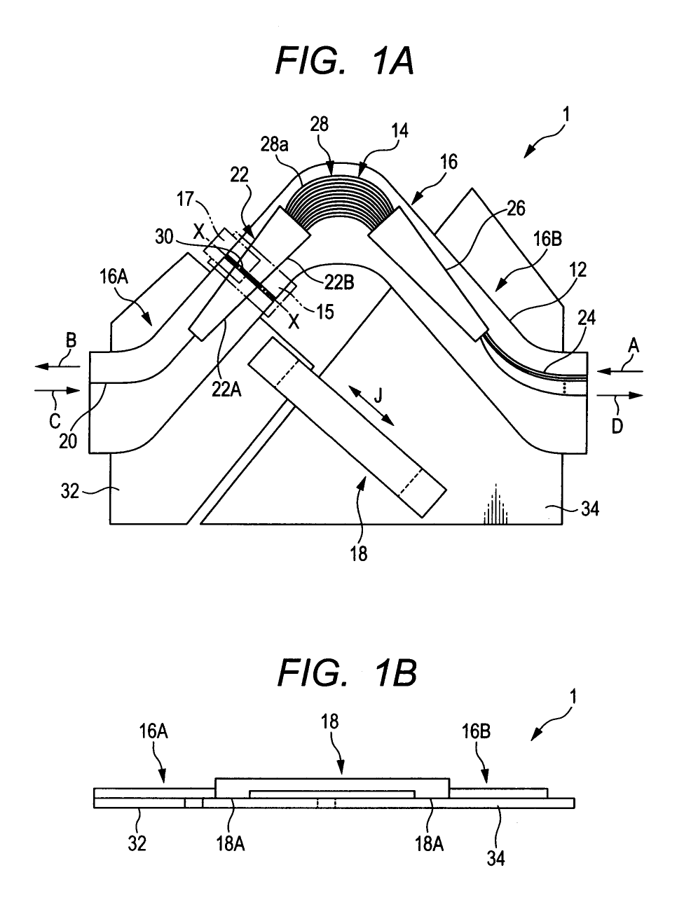

FIG. 1A and FIG. 1B show a plan view and a side view of an arrayed waveguide grating type optical multiplexer and demultiplexer 1 according to Embodiment 1, respectively. As shown in FIG. 1A and FIG. 1B, the arrayed waveguide grating type optical multiplexer and demultiplexer 1 according to Embodiment 1 includes one waveguide chip 16 having an approximately boomerang-like planar shape.

The waveguide chip 16 has a substrate 12 made of silicon and an arrayed waveguide grating 14 formed on the substrate 12. Then, the arrayed waveguide grating 14 includes at least one first waveguide 20, a first slab waveguide 22 connected to the first waveguide 20, an arrayed waveguide 28 having one end connected to a side opposite to a side connected with the first waveguide 20 in the first slab waveguide 22 and also including plural channel waveguides 28a, a second slab waveguide 26 connected to the other end of the arrayed waveguide 28, and plural second waveguides 24 connected in a state provided in parallel to one another on a side opposite to the arrayed waveguide 28 in the second slab waveguide 26.

Here, the arrayed waveguide grating 14 is a planar lightwave circuit (PLC) in which an optical waveguide is fabricated to include a core and a cladding which are formed on the silicon substrate 12 by a combination of a flame hydrolysis deposition method (FHD method), an optical fiber manufacturing technique, and a semiconductor micro-fabrication technique. A quartz substrate may be used as the substrate instead of the silicon substrate.

Further, the channel waveguides 28a constituting the arrayed waveguide 28 have respective lengths different from one another and are disposed on the waveguide chip 16 from one side edge toward the other side edge in the ascending order of length. Accordingly, the arrayed waveguide 28 has a shape bending in a specified direction as shown in FIG. 1A. Then, the waveguide chip 16 is cut in a curved shape along the outline of the arrayed waveguide grating 14 and configured to have a shape (boomerang shape) bending along the bending direction of the arrayed waveguide 28.

Further, in the waveguide chip 16, the first slab waveguide 22 is divided together with the substrate 12 by a cut plane 30 which is a vertical plane crossing the optical axis thereof. Accordingly, also the arrayed waveguide grating 14 is divided into two by the cut plane 30.

That is, the waveguide chip 16 is divided by the cut plane 30 into a first separated waveguide chip 16A and a second separated waveguide chip 16B, respectively. Further, the first slab waveguide 22 is divided by the cut plane 30 into two of a first separated slab waveguide 22A and a second separated slab waveguide 22B in each of the waveguide chips 16. Note that the waveguide chip may be cut in the second slab waveguide 26 instead of being cut in the first slab waveguide 22.

The first separated slab waveguide 22A, in the first slab waveguides 22 divided into two sides, denotes one side connected with the first waveguide 20 and the second separated slab waveguide 22B denotes the other side connected with the arrayed waveguide 28. Then, the first separated waveguide chip 16A, in the waveguide chips 16 divided into two sides, denotes one side including the first separated slab waveguide 22A, and the second separated waveguide chip 16B denotes the other side including the second separated slab waveguide 22B.

Further, in the substrate 12 divided into two sides by the cut plane 30, a substrate on a side to which the first separated waveguide chip 16A is fixed is called a first substrate 12A, and a substrate on the other side on which the second separated waveguide chip 16B is formed is called a second substrate 12B.

The first substrate 12A and the second substrate 12B may be formed in a manner such that a relative positional change in a desired direction is secured in a required amount for one and the other sides of the arrayed waveguide grating 14 divided into two by the cut plane 30. Accordingly, the first substrate 12A and the second substrate 12B may be connected to each other at one part thereof without being separated completely.

In the waveguide chip 16, the first separated waveguide chip 16A and the second separated waveguide chip 16B are fixed to a first glass plate 32 which is an example of the first base of the present invention and a second glass plate 34 which is an example of the second base of the present invention, respectively. Note that the second separated waveguide chip 16B is bonded and fixed to the second glass plate 34 at a part except the part on which the arrayed waveguide 28 is formed, for example, at the part for the second slab waveguide 26 and the second waveguide 24. Further, each of the first glass plate 32 and the second glass plate 34 is formed into a shape in which the part to otherwise support the arrayed waveguide 28 is cut out. Accordingly, the part for the arrayed waveguide 28 in the arrayed waveguide grating 14 is not fixed to any of the first glass plate 32 and the second glass plate 34. Here, since any of the first glass plate 32 and the second glass plate 34 is made of silica glass and ultraviolet light can be transmitted through the bases, ultraviolet curable adhesive can be used for bonding the first separated waveguide chip 16A to the first glass plate 32 and for bonding the second separated waveguide chip 16B to the second glass plate 34.

In this manner, without bonding and fixing the part of the waveguide chip 16 where the arrayed waveguide 28 is formed, it is possible to realize an arrayed waveguide grating type optical multiplexer and demultiplexer in which a low crosstalk can be obtained stably even when temperature changes. Note that, while the present embodiment uses the second glass plate 34 having the shape in which the part to otherwise support the arrayed waveguide 28 is cut out, the same effect can be obtained if the part for the arrayed waveguide 28 is not bonded or fixed, even when the part to otherwise support the arrayed waveguide 28 is not cut out. Note that, by means of cutting out the part to otherwise support the arrayed waveguide 28, it is possible to realize cost down, and further it becomes easy to perform adhesive control, which makes it easy to perform the work.

Further, the waveguide chip 16 is formed into the planar shape which bends in the same direction as the bending direction of the arrayed waveguide and in the same curvature as that of the arrayed waveguide. Accordingly, it is possible to realize a compact configuration compared to an arrayed waveguide grating type optical multiplexer and demultiplexer having a waveguide chip of a rectangular outer shape.

Further, the arrayed waveguide grating type optical multiplexer and demultiplexer 1 includes a rectangle-shaped compensation member 18 which crosses over the first glass plate 32 and the second glass plate 34, and one side of which is fixed to the upper surface of the first glass plate with adhesive and the other side of which is fixed to the upper surface of the second glass plate 34 with adhesive. This compensation member is disposed in a manner such that a long side (longitudinal direction) thereof is parallel to the extension direction of the cut plane 30. Here, the present embodiment uses a metal plate made of copper or pure aluminum (JIS: A1050) for the compensation member 18. As shown in FIG. 1B, leg parts 18A are provided to protrude from both ends of the compensation member 18, respectively, and these leg parts 18A are fixed to the first glass plate 32 and the second glass plate 34 with adhesive, respectively. Thereby, respective bonding areas of the compensation member 18 with the first glass plate 32 and the second glass plate 34 are made constant.

Here, when the bonding area is different, sometimes an effective length changes and temperature characteristic has a variation.

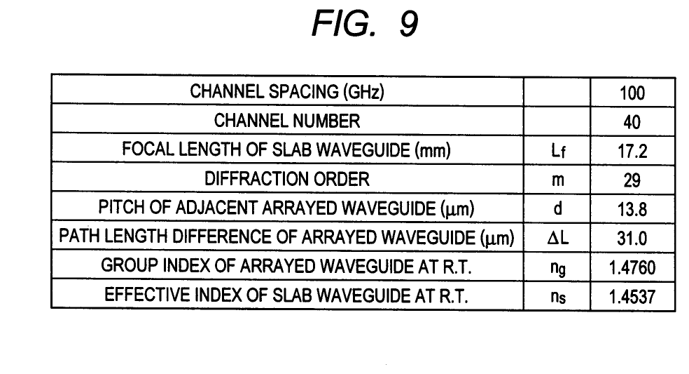

The length of this compensation member is calculated from the following Formula 1 by the use of the circuit parameters of the arrayed waveguide grating 14 shown in FIG. 9, and the length is 18 mm in the present embodiment.

$$dx = \frac{{L}_{f} Δ L}{{n}_{s} d {λ}_{0}} {n}_{g} \frac{d λ}{d T} \qquad [ Formula 1 ]$$

With this configuration, when temperature changes, a light collection position by the first slab waveguide 22 (light collection position of the first separated slab waveguide 22A by the first slab waveguide 22) changes by dx. However, the compensation member 18 expands or contracts by dx due to the temperature change, and then the first glass plate 32 and the second glass plate 34 are moved relatively along the cut plane 30. Thereby, the first separated slab waveguide 22A also is moved relatively with respect to the second separated slab waveguide 22B along the cut plane 30. Accordingly, the light collection position of the first slab waveguide 22 is corrected (dx−dx=0).

In the waveguide chip 16, a wavelength multiplexed optical signal multiplexing optical signals having respective wavelengths different from one another is input into the first waveguide 20, or a wavelength multiplexed optical signal is output from the first waveguide 20. The first slab waveguide 22 has a function of demultiplexing the wavelength multiplexed optical signal input from the first waveguide 20 for each wavelength and a function of multiplexing optical signals which have respective wavelengths different from one another and propagated through the arrayed waveguide 28.

In the arrayed waveguide 28, the channel waveguides 28a each having a function of transmitting an optical signal for each wavelength are provided at a predetermined pitch d in a number of, for example, 100, corresponding to the number of channels of the wavelength multiplexed optical signal input into the first waveguide 20. In the present embodiment, the pitch d of the channel waveguides 28a is set to be 13.8 μm, but the pitch d is not limited to this length.

Further, since the optical signal having a different wavelength propagates through each of the channel waveguides 28a, each of the channel waveguides 28a has a different length corresponding to the wavelength of the light to be propagated. Accordingly, the lengths of the neighboring two channel waveguides 28a are different from each other by a setup amount ΔL as described above. In the present embodiment, the setup amount ΔL is set to be 31.0 μm as shown in FIG. 9.

The second waveguides 24 are provided in a number corresponding to the number of the channels of the wavelength multiplexed optical signal input into the first waveguide 20, that is, in the same number as that of the channel waveguides 28a.

Further, in the arrayed waveguide grating type optical multiplexer and demultiplexer 1, as shown in FIG. 1A by a two-dot chain line, the part of the waveguide chip 16 cut by the cut plane 30 may be sandwiched by back plates 15 from both sides and sandwiched and held by a clip 17 from over the back plates 15.

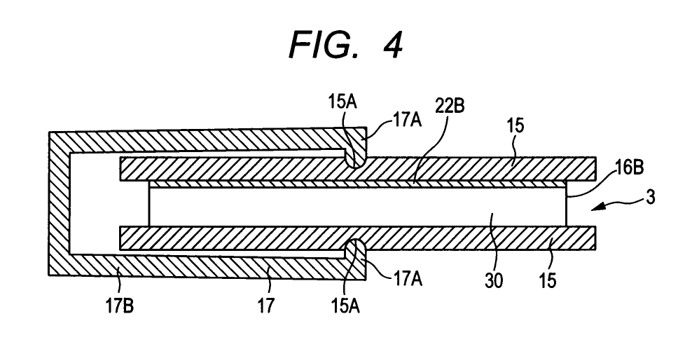

FIG. 4 shows a cross section (X-X cross section of FIG. 1A) of cutting in the thickness direction along the cut plane 30. As shown in FIG. 4, the part of the waveguide chip 16 cut by the cut plane 30 is sandwiched by the back plates 15 from both sides and sandwiched and held by the clip 17 from over the back plates 15. A groove 15A is formed in a center part of the back plate 15 along the optical axis of the first slab waveguide 22 as shown in FIG. 4.

On the other hand, the clip 17 has an approximately C-shaped cross section and includes opening side edge parts 17A bent inside so as to face each other and a spring part 17B biased so as to make the opening side edge parts 17A come close to each other.

The end edge of the opening side edge part 17A in the clip 17 is formed so as to fit the groove 15A formed in the back plate 15.

Next, a manufacturing process of the arrayed waveguide grating type optical multiplexer and demultiplexer 1 according to the present embodiment will be explained.

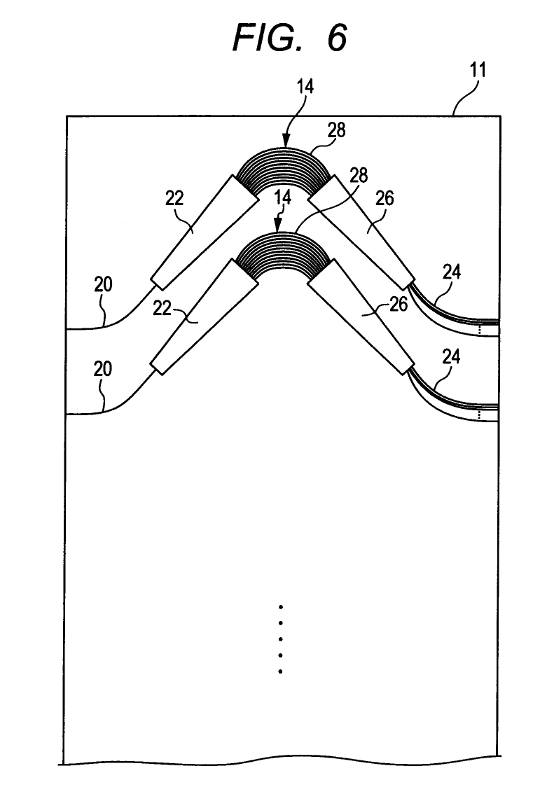

As shown in FIG. 6, a predetermined number of the arrayed waveguide gratings 14 are formed on one silicon wafer 11 in a condensed state.

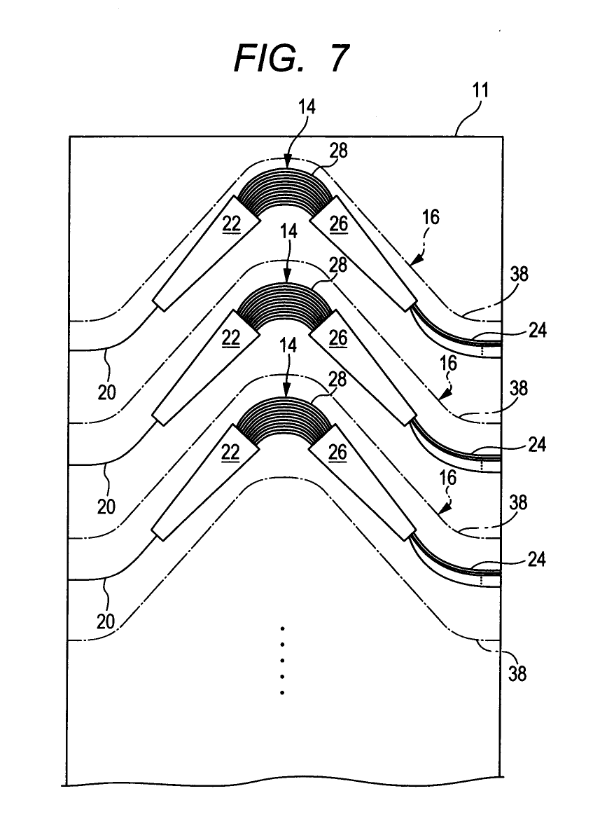

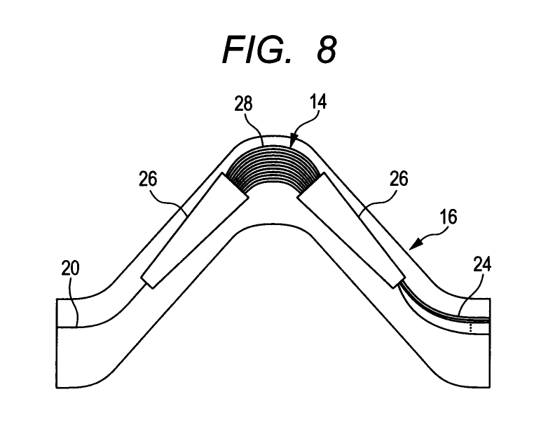

Next, the silicon wafer 11, on which the arrayed waveguide gratings 14 are formed, is cut in a curved shape along a cut line 38 by the use of a laser beam machine (e.g., CO₂ laser) as shown in FIG. 7. Thereby, the predetermined number of waveguide chips 16, each of which includes the substrate 12 having the boomerang-like outer shape, are obtained as shown in FIG. 8.

After the fabrication of the waveguide chip 16, the waveguide chip 16 is cut in the direction perpendicular to the optical axis (center line) of the first slab waveguide 22 together with the substrate 12 in the part for the first slab waveguide 22, and divided into two of the first separated waveguide chip 16A (refer to FIG. 1A) and the second separated waveguide chip 16B (refer to FIG. 1A). The first separated waveguide chip 16A and the second separated waveguide 16B obtained in this manner are bonded and fixed to the first glass plate 32 and the second glass plate 34, respectively. Further, the compensation member 18 is attached in a manner such that a center wavelength of the arrayed waveguide grating 14 matches a wavelength of the ITU-T grid.

Specifically, one of the legs 18A of the compensation member 18 is fixed with adhesive to the upper surface of the first glass plate 32 and the other leg 18A is fixed with adhesive to the upper surface of the second glass plate 34 in a manner such that a long side of the compensation member 18 is parallel to the extension direction of the cut plane 30. By the above process, the arrayed waveguide grating type optical multiplexer and demultiplexer 1 is fabricated.

### Operation and Advantage

Next, the operation of the arrayed waveguide grating type optical multiplexer and demultiplexer 1 will be explained.

When the arrayed waveguide grating type optical multiplexer and demultiplexer 1 is used for multiplexing (MUX), in the waveguide chip 16, as shown in FIG. 1A by the arrow A, plural optical signals having respective wavelengths different from one another (λ1 to λn) are input individually from the second waveguides 24.

The input optical signals (λ1 to λn) are input individually into the respective channel waveguides 28a in the arrayed waveguide grating 14 through the second slab waveguide 26.

The optical signals (λ1 to λn) propagated in the respective channel waveguides 28a are multiplexed in the first slab waveguide 22 and output from the first waveguide 20 as a wavelength multiplexed optical signal as shown in FIG. 1A by the arrow B.

Here, when temperature changes, a light collection position in the first slab waveguide 22 (light collection position of the second separated slab waveguide 22B in the first slab waveguide 22) changes, but the first separated slab waveguide 22A is moved relatively against the second separated slab waveguide 22B by the expansion or contraction of the compensation member 18 as shown in FIG. 1 by the arrow J and the light collection position is corrected. Thereby, even when temperature changes, it is possible to take out the optical signal having the same wavelength from the first waveguide 20. That is, in the arrayed waveguide grating 14, a wavelength multiplexed optical signal multiplexed with the plural optical signals having the same wavelengths (λ1 to λn) as those of the input plural optical signals (λ1 to λn), respectively, is output from the first waveguide 20.

On the other hand, when the arrayed waveguide grating type optical multiplexer and demultiplexer 1 is used for demultiplexing (DEMUX), in the waveguide chip 16, as shown in FIG. 1A by the arrow C, a wavelength multiplexed optical signal multiplexed with the plural optical signals having respective wavelengths different from one another (λ1 to λn) is input from the first waveguide 20.

The input wavelength multiplexed optical signal is demultiplexed in the first slab waveguide into n optical signals having respective wavelengths (λ1, λ2, ζ3, . . . , λn) and the n optical signals are input individually into the channel waveguides 28a.

The optical signals propagated individually through the channel waveguides 28a pass through the second slab waveguide 26 and are output individually from the respective second waveguides 24 as shown in FIG. 1A by the arrow D. That is, in the arrayed waveguide grating 14, the wavelength multiplexed optical signal multiplexed with the plural optical signals having respective wavelengths different from one another (λ1 to λn) is input from the first waveguide 20 and demultiplexed for each of the wavelengths to be output from the second waveguide 24.

Here, when temperature changes, the light collection position in the first separated slab waveguide 22A of the first slab waveguide 22 changes, but the first separated slab waveguide 22A is moved relatively against the second separated slab waveguide 22B by the expansion or contraction of the compensation member 18 and the light collection position is corrected. Thereby, even when temperature changes, the optical signal having the same wavelength is taken out from one of the second waveguides 24. That is, the optical signal having the same wavelength as each of the wavelengths λ1 to λn in the input wavelength multiplexed optical signal is output individually from the second waveguide 24.

In the arrayed waveguide grating type optical multiplexer and demultiplexer 1, since the compensation member 18 is fixed to the first glass plate 32 and the second glass plate 34, it is possible to determine the respective shapes of the first separated waveguide chip 16A and the second separated waveguide chip 16B without consideration of a space in the waveguide chip 16 where the compensation member 18 is to be bonded. Further, the waveguide chip 16 is configured to have the approximately boomerang-like planar shape in which the waveguide chip 16 as a whole is bent in the same bending direction and in the same curvature as the arrayed waveguide grating 14.

Therefore, a package size can be made equivalent to or smaller than that of an arrayed waveguide grating type optical multiplexer and demultiplexer including a waveguide chip having a rectangular planar shape.

Further, since the waveguide chip 16 is configured to have the approximately boomerang-like outer shape by means of cutting each of the plural arrayed waveguide gratings 14 formed on the single silicon wafer 11 in a curved shape along the outline of each of the arrayed waveguide gratings 14 by using the laser beam machine, the number of the waveguide chips 16 fabricated from the single silicon wafer 11 can be increased compared to a case in which the waveguide chip 16 has an rectangular outer shape.

Further, the waveguide chip 16 is cut by the cut plane 30 in the part for the first slab waveguide 22 in a direction perpendicular to the optical axis (center line) thereof, and the first separated slab waveguide 22A moves relatively against the second separated slab waveguide 22B along the cut plane 30 when the compensation member is fixed to the first glass plate 32 and the second glass plate 34 so as to make a long side thereof parallel to the longitudinal direction of the cut plane 30. In this manner, by means of causing the divided first separated slab waveguide 22A to move relatively against the second separated slab waveguide 22B along the cut plane 30, the light collection position of the first slab waveguide 22 can be corrected precisely.

In addition, by means of causing the waveguide chip 16 to have the boomerang-like outer shape, a cut line does not remain to the chip and thereby it is possible to improve a mechanical strength of the waveguide chip 16 against shock, vibration, or the like, compared to a case in which the chip is cut by the use of a dicing machine.

Additionally, for a case in which the first separated waveguide chip 16A and the second separated waveguide chip 16B are sandwiched and held in the thickness direction by the back plates 15 and the clip 17 at the cut plane 30, that is, at the boundary part thereof, a shift in the thickness direction is prevented to be caused between the first separated waveguide chip 16A and the second separated waveguide chip 16B when the first separated waveguide chip 16A is moved relatively against the second separated waveguide chip 16B by the expansion or contraction of the compensation member 18.

Further, there is not an influence of a dimensional error in the first glass plate 32 or the second glass plate 34 in the thickness direction.

### 2. Embodiment 2

In the following, another example of the arrayed waveguide grating type optical multiplexer and demultiplexer according to the present invention will be explained.

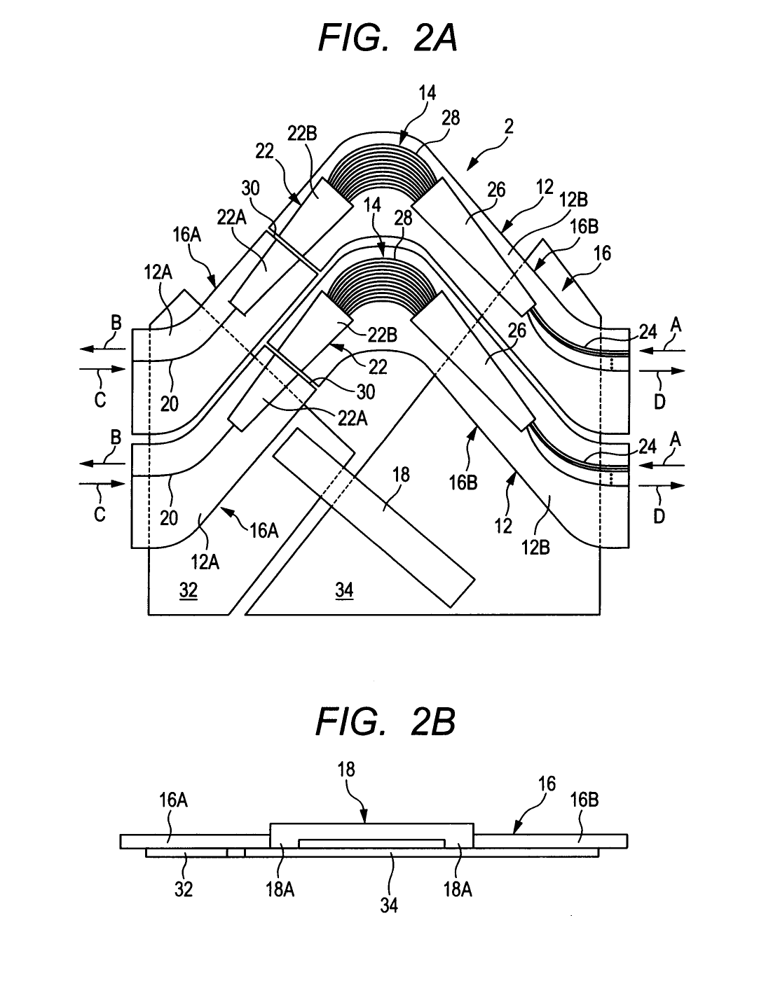

FIG. 2A and FIG. 2B show a plan view and a side view of an arrayed waveguide grating type optical multiplexer and demultiplexer 2 according to Embodiment 2, respectively. As shown in FIG. 2A and FIG. 2B, the arrayed waveguide grating type optical multiplexer and demultiplexer 2 according to Embodiment 2 includes two waveguide chips 16 provided in parallel to each other. Here, the configuration of the waveguide chip 16 is the same as that of Embodiment 1. Further, the number of the waveguide chips 16 is not limited to two and may be three or larger.

As shown in FIG. 2A, each of the waveguide chips 16 is cut by one cut plane 30 in a part for a first slab waveguide 22 in an arrayed waveguide grating 14 to be divided into a first separated waveguide chip 16A and a second separated waveguide chip 16B. Accordingly, the first slab waveguide 22 is also separated by the cut plane 30 into a first separated slab waveguide 22A and a second separated slab waveguide 22B.

In each of the two waveguide chips 16, the first separated waveguide chip 16A and the second separated waveguide chip 16B are bonded and fixed to a common first glass plate 32 and a common second glass plate 34, respectively. Note that, in either of the waveguide chips 16, the second separated waveguide chip 16B is bonded and fixed to the second glass plate 34 at a part except the arrayed waveguide 28 in an arrayed waveguide grating 14. Further, a part for the arrayed waveguide 28 in the second separated waveguide chip 16B is not fixed to any of the first glass plate 32 and the second glass plate 34.

The arrayed waveguide grating type optical multiplexer and demultiplexer 2 has the following advantage in addition to the advantage provided for the arrayed waveguide grating type optical multiplexer and demultiplexer 1 according to Embodiment 1.

First, it is possible to perform temperature compensation for the two waveguide chips 16 by a common compensation member 18.

Accordingly, although including the plural waveguide chips 16, by means of reducing the gap between the two waveguide chips 16 neighboring each other, the arrayed waveguide grating type optical multiplexer and demultiplexer 2 can be formed in an area equivalent to that of the arrayed waveguide grating type optical multiplexer and demultiplexer 1 according to Embodiment 1 which includes only one waveguide chip 16.

Therefore, the package size can be reduced to a size equivalent to or smaller than that of an existing product.

Further, each of the waveguide chips 16 can have the same configuration and the number of the compensation members 18 may be one, and thereby the component is easily commonized and cost merit is easily obtained.

### 3. Embodiment 3

In the following still another example of the arrayed waveguide grating type optical multiplexer and demultiplexer according to the present invention will be explained.

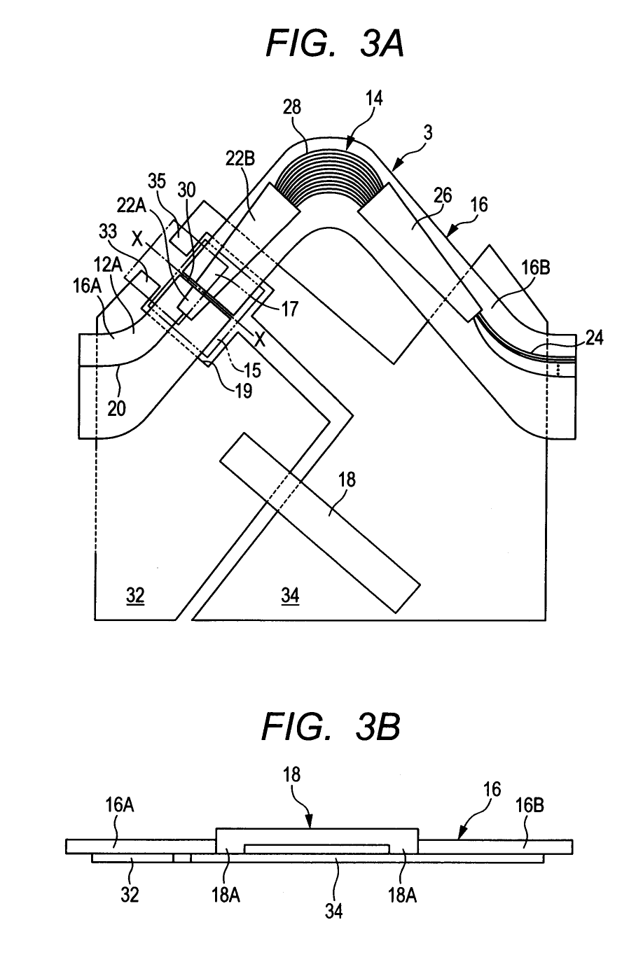

FIG. 3A and FIG. 3B show a plan view and a side view of an arrayed waveguide grating type optical multiplexer and demultiplexer 3 according to Embodiment 3, respectively. Further, FIG. 4 shows a cross section of cutting in the thickness direction along a cut plane 30 (X-X cross section of FIG. 3A). In the arrayed waveguide grating type optical multiplexer and demultiplexer 3 according to Embodiment 3, the same as in Embodiment 1, a part where a waveguide chip 16 is cut by the cut plane 30 is sandwiched between back plates 15 from both sides and sandwiched and held by a clip 17 from over the back plates 15 as shown in FIG. 4.

In a second glass plate 34, a part corresponding to an arrayed waveguide 28 is cut out as shown in FIG. 3A, and the second glass plate 34 faces a first glass plate 32 in an approximately dogleg shape. Further, a rectangular opening part 19 is formed at a part corresponding to the cut plane 30 of a first slab waveguide 22. Here, a protrusion part 33 and a protrusion part 35 are formed in the first glass plate 32 and the second glass plate 34, respectively, and the rectangular opening part 19 is formed by the protrusion part 33, the first glass plate 32, the protrusion part 35, and the second glass plate 34. Then, the positioning of the back plate 15 and the clip 17 is performed by the opening part 19.

Except for the above point, the arrayed waveguide grating type optical multiplexer and demultiplexer 3 has the same configuration as the arrayed waveguide grating type optical multiplexer and demultiplexer 1 according to Embodiment 1.

The arrayed waveguide grating type optical multiplexer and demultiplexer 3 has the following advantage in addition to the advantage of the arrayed waveguide grating type optical multiplexer and demultiplexer 1 according to Embodiment 1. That is, in the arrayed waveguide grating type optical multiplexer and demultiplexer 3, it is easy to align the respective positions of the back plate 15 and the clip 17 with a dividing part of an arrayed waveguide grating 14 divided into two, by aligning the respective positions of the back plate 15 and the clip 17 with the opening part 19.

### 4. Embodiment 4

In the following, still another example of the arrayed waveguide grating type optical multiplexer and demultiplexer according to Embodiment 4 will be explained.

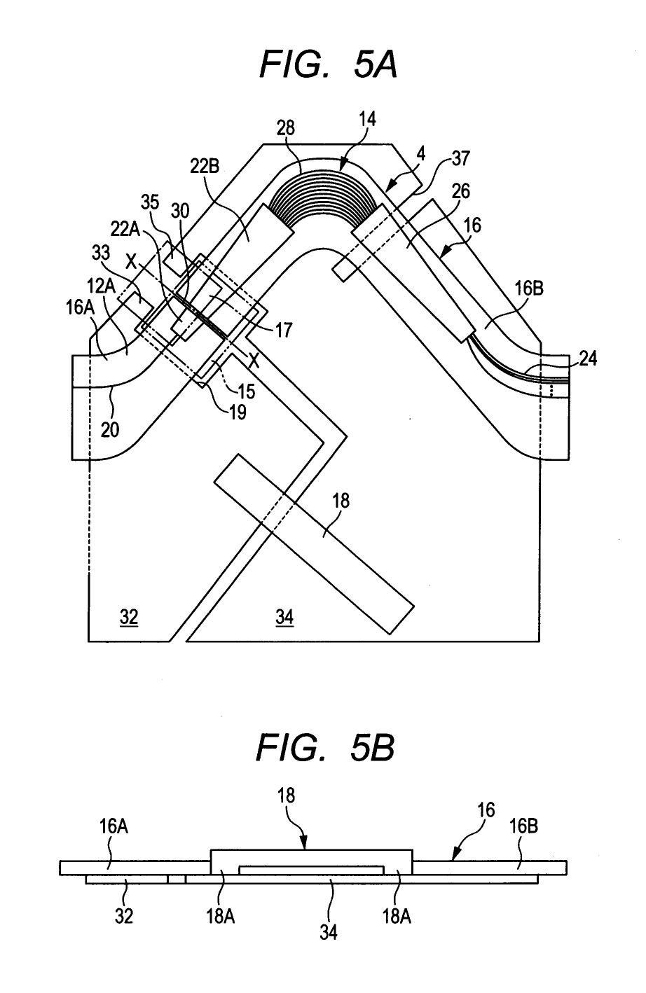

FIG. 5A and FIG. 5B show a plan view and a side view of the arrayed waveguide grating type optical multiplexer and demultiplexer 4 according to Embodiment 4, respectively.

In the arrayed waveguide grating type optical multiplexer and demultiplexer 4, as shown in FIG. 5A and FIG. 5B, a part corresponding to an arrayed waveguide 28 is not cut out from the second glass plate 34 and the second glass plate 34 is formed over almost the whole area of a part corresponding to a second separated waveguide chip 16B. Note that a cut-in part 37 is formed at a part of the second glass plate 34 corresponding to a second slab waveguide 26 so as to intersect the second slab waveguide 26. Then, a second separated waveguide chip 16B is bonded to the second glass plate 34 only at a part on the side of a second waveguide 24 from the boundary of the cut-in part 37 in a part where the second slab waveguide 26 is formed, and a part where the arrayed waveguide 28 is formed is not bonded to the second glass plate 34.

Except for the above point, the arrayed waveguide grating type optical multiplexer and demultiplexer 4 has the same configuration as the arrayed waveguide grating type optical multiplexer and demultiplexer 3 of Embodiment 3.

In the arrayed waveguide grating type optical multiplexer and demultiplexer 4, the cut-in part 37 provided in the second glass plate 34 functions as a flow stop of adhesive and thereby the adhesive does not flow to the part where the arrayed waveguide 28 is formed in the second separated waveguide chip 16B. Accordingly, when temperature changes, a part of the second separated waveguide chip 16B where the arrayed waveguide 28 and a second separated waveguide 22B are formed is not affected by expansion or contraction of the second glass plate 34, and thereby it is possible to suppress the occurrence of crosstalk due to temperature change.

Further, it is possible to increase a strength of a protrusion part 35 compared to the case of the arrayed waveguide grating type optical multiplexer and demultiplexer 3 according to Embodiment 3.

While, hereinabove, Embodiments 1 to 4 of the present invention have been explained, the present invention is not limited to these embodiments and it is obvious to those skilled in the art that other various embodiments can be made within the scope of the present invention. For example, while in the above embodiments, the outline of the waveguide chip 16 is cut by the use of the CO₂ laser, the present invention is not limited to this example, and the outline of the waveguide chip 16 may be cut by the use of any of various kinds of laser, a water jet, or the like.

Further, while, in the above embodiments, the waveguide chip 16 is divided into the first separated waveguide chip 16A and the second separated waveguide chip 16B by means of cutting the part of the first slab waveguide 22 together with the substrate 12 in the direction perpendicular to the optical axis (center line) of the first slab waveguide 22, the present invention is not limited to this example, and the waveguide chip 16 may be cut in a direction obliquely crossing the optical axis (center line) of the first slab waveguide 22.

Further, while in the above embodiments, the silica glass plate is used as the base to which each of the first separated waveguide chip 16A and the second separated waveguide chip 16B is bonded, the present invention is not limited to this example and another material may be used.

Further, the bonding area of the first glass plate 32 and the first separated waveguide chip 16A, the bonding area of the second glass plate 34 and the second separated waveguide chip 16B, and the bonding position of the compensation member 18 are not limited to the above embodiments, if the respective positions of the cut slab waveguides can be changed relatively in a required amount by the expansion or contraction of the compensation member 18.

Note that the bonding plane between the first separated waveguide 16A and the first glass plate preferably crosses the extension line of the compensation member 18 in the longitudinal direction. In this manner, by means of performing the bonding on the extension line of the compensation member 18 in the longitudinal direction, a hysteresis of a center wavelength shift due to a temperature history becomes small and the temperature dependence of the center wavelength becomes stable.

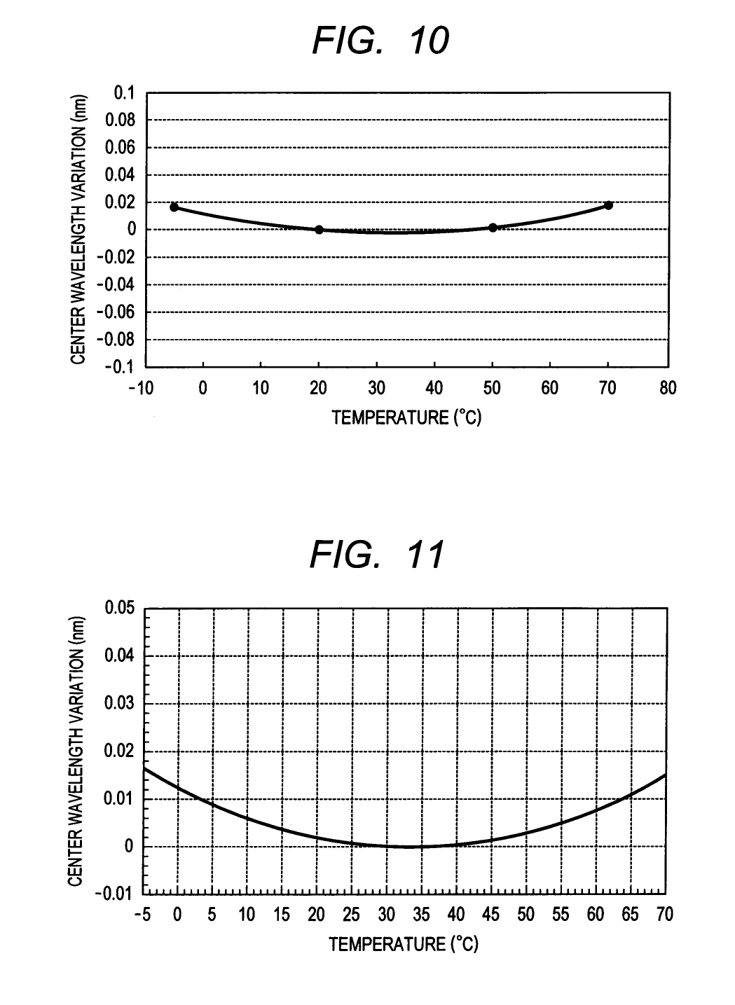

FIG. 10 shows a center wavelength variation when a temperature history of 20° C. to 50° C. to 70° C. to 50° C. to 20° C. to −5° C. to 20° C. has been applied to the arrayed waveguide grating type optical multiplexer and demultiplexer shown in FIG. 1A and FIG. 1B in which the bonding is performed on the extension line of the compensation member 18 in the longitudinal direction. As apparent from FIG. 10, the center wavelength has the same value at 20° C. and 50° C. even when such a temperature history has been applied.

Further, while, in the above embodiments, the case in which one side of the compensation member 18 is fixed to the first glass plate 32 is explained as an example, the present invention is not limited to this example and one side of the compensation member 18 may be fixed to the first glass plate 32 via the first separated waveguide chip 16A.

Further, while, in the above embodiments, the case in which the other end of the compensation member 18 is fixed to the second glass plate 34 is explained as an example, the present invention is not limited to this example and the other end of the compensation member 18 may be fixed to the second glass plate 34 via the second separated waveguide chip 16B by means of changing the shape of the compensation member 18 or the second separated waveguide chip 16B.

### EXAMPLE

### (1) Example 1

An arrayed waveguide grating type optical multiplexer and demultiplexer 1 described in Embodiment 1 was fabricated and a temperature characteristic of this arrayed waveguide grating type optical multiplexer and demultiplexer 1 was evaluated.

In the arrayed waveguide grating type optical multiplexer and demultiplexer 1, as shown in FIG. 11, a center wavelength variation of ±0.010 nm could be realized in a temperature range of −5 to 70° C., and it was confirmed that there was not a practical problem.

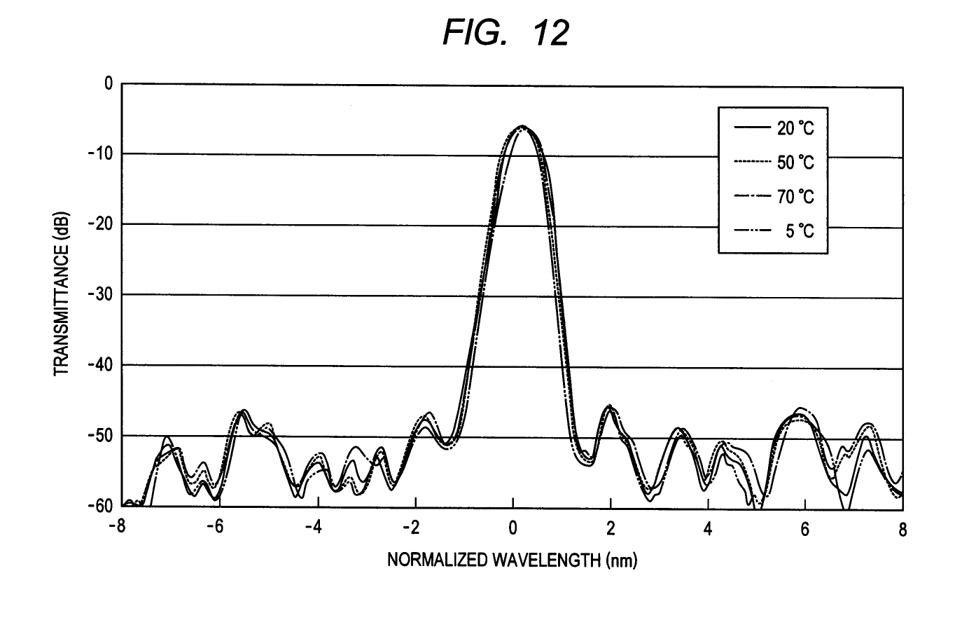

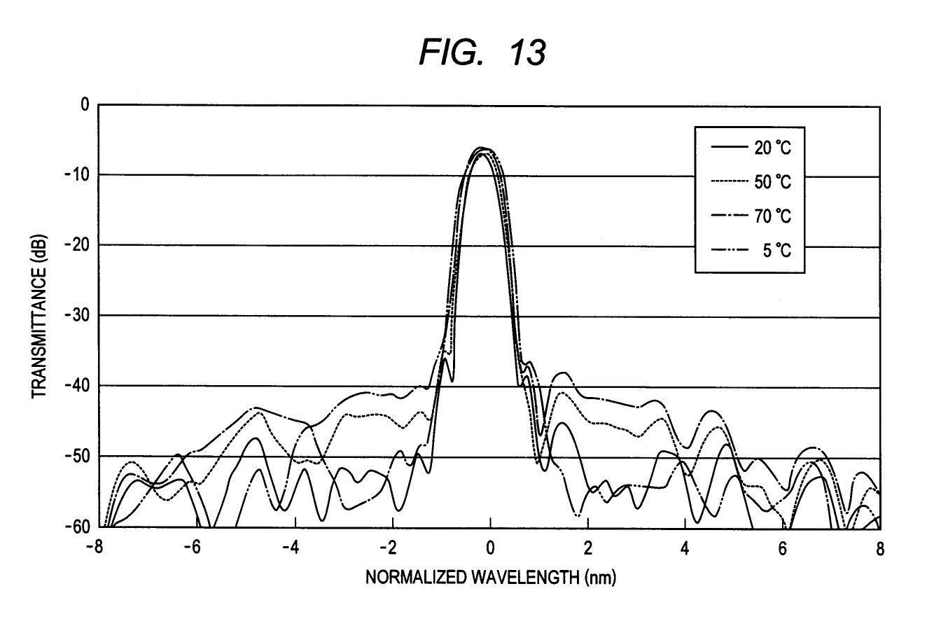

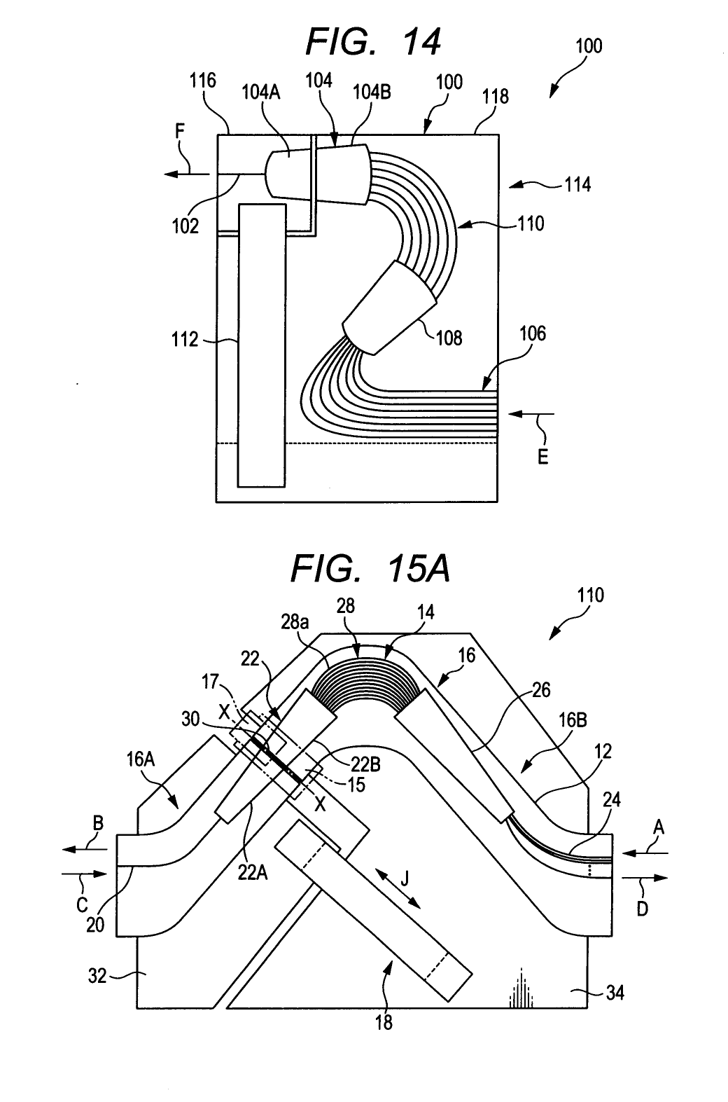

Next, a loss-wavelength characteristic and temperature variation thereof in the arrayed waveguide grating type optical multiplexer and demultiplexer 1 is shown in the graph of FIG. 12. Here, in FIG. 12, the horizontal axis shows a relative shift amount from a center transmission wavelength and the vertical axis shows a loss. Further, the solid line, the broken line, the chain line, and the two-dot chain line show results at 20° C., 50° C., 70° C., and −5° C., respectively.

As apparent from FIG. 12, in the arrayed waveguide grating type optical multiplexer and demultiplexer 1 according to the present embodiment, the distortion of the spectrum is stable without depending on temperature and a low crosstalk is obtained even when temperature changes. Accordingly, crosstalk is small. This is because, in the arrayed waveguide grating type optical multiplexer and demultiplexer 1 according to the present embodiment, the arrayed waveguide 28 is not fixed with adhesive to the second glass plate 34, and thereby an influence to the arrayed waveguide caused by a difference between the linear expansion coefficient of the second separated waveguide chip 16B and the linear expansion coefficient of the second glass plate 34 is suppressed when ambient temperature increases or decreases.

### (2) Comparative example 1

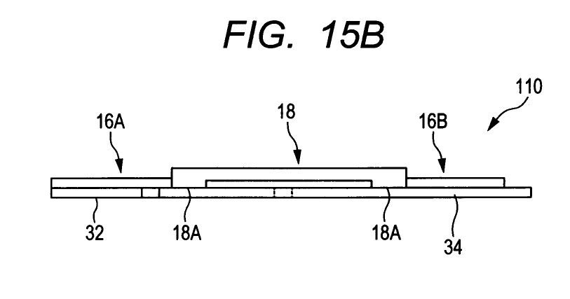

An arrayed waveguide grating type optical multiplexer and demultiplexer 110 was fabricated and a temperature characteristic thereof was evaluated. The arrayed waveguide grating type optical multiplexer and demultiplexer 110 has the same configuration as the Embodiment 1 except that the shape of the second glass plate 34 is changed and the whole substrate 12B including the part for the arrayed waveguide 28 in the second separated waveguide chip 16B is bonded and fixed to the second glass plate 34. A plan view and a side view of the arrayed waveguide grating type optical multiplexer and demultiplexer 110 according to Comparative example 1 are shown in FIG. 15A and FIG. 15B, respectively.

Also in the above arrayed waveguide grating type optical multiplexer and demultiplexer, as shown in FIG. 11, a center wavelength variation of ±0.010 nm could be realized in a temperature range of −5 to 70° C., and it was confirmed that there was not a practical problem.

Next, a loss-wavelength characteristic and temperature variation thereof in the above arrayed waveguide grating type optical multiplexer and demultiplexer 110 is shown in the graph of FIG. 13. Here, in FIG. 13, the horizontal axis shows a relative shift amount from a center transmission wavelength and the vertical axis shows a loss. Further, the solid line, the broken line, the chain line, and the two-dot chain line show results at 20° C., 50° C., 70° C., and −5° C., respectively.

As apparent from FIG. 13, in the arrayed waveguide grating type optical multiplexer and demultiplexer 110 of Comparative example 1, the spectrum distortion is different for each temperature and the crosstalk becomes unstable when temperature changes. Accordingly, the crosstalk is large.

1. An arrayed waveguide grating type optical multiplexer and demultiplexer, comprising:
a waveguide chip having an arrayed waveguide grating including at least one first waveguide, a first slab waveguide connected to the first waveguide, an arrayed waveguide having one end connected to a side opposite to a side connected with the first waveguide in the first slab waveguide and including a plurality of channel waveguides having respective lengths different from one another and being bent in the same direction, a second slab waveguide connected to the other end of the arrayed waveguide, and a plurality of second waveguides connected in a state provided in parallel to one another on a side opposite to a side connected with the arrayed waveguide in the second slab waveguide, wherein the waveguide chip is divided into a first separated waveguide chip and a second separated waveguide chip in any of the first slab waveguide and the second slab waveguide;
a first base for supporting the first separated waveguide chip;
a second base for supporting the second separated waveguide chip; and
a compensation member compensating a temperature dependent shift of a light transmission center wavelength of the arrayed waveguide grating in the waveguide chip by being expanded and contracted according to a temperature change so that a relative position between the first and second separated waveguide chips is shifted, wherein
the first separated waveguide chip is fixed to the first base at least at a part of a region not including the arrayed waveguide and
the second separated waveguide chip is fixed to the second base at least at a part of a region not including the arrayed waveguide.

2. The arrayed waveguide grating type optical multiplexer and demultiplexer according to claim 1, wherein
a part supporting a region including the arrayed waveguide in at least one of the first and second separated waveguide chip is cut out in each of the first and second bases.

3. The arrayed waveguide grating type optical multiplexer and demultiplexer according to claim 1, wherein
a boundary part of the waveguide chip divided into two is sandwiched and held by a clip in a thickness direction.

4. The arrayed waveguide grating type optical multiplexer and demultiplexer according to claim 3, wherein
an opening part for positioning the clip is formed in the first and second bases.
